(19) United States
(12) Patent Application Publication
(10) Pub. No.: US 2009/0158250 A1
(43) Pub. Date: Jun. 18, 2009

(54) SYSTEMS, METHODS AND COMPUTER PROGRAM PRODUCTS FOR OPERATION HISTORY MANAGEMENT FOR HPC PROGRAMS OPTIMIZATION

(75) Inventors: Hirofumi Kimura, Tokyo (JP); Hiroki Murata, Tokyo (JP); Yasushi Negishi, Tokyo (JP)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/958,475

(22) Filed: Dec. 18, 2007

(51) Int. Cl. G06F 9/44

(52) U.S. Cl. 717/113

(57) ABSTRACT

Systems, methods and computer program products for operation history management for high performance computing programs optimization. Exemplary embodiments include a method including in response to saving an operation history creating a pseudo-change file that includes marks above and below an operation area in order to specify an operation object, creating a change history by storing context differences between contents of a file before an operation and the pseudo-change file, including the context differences in an operation history list, in response to applying the operation history applying the context differences to an objective operation file to acquire the pseudo-change file, determining the application area based on a position of the marks above and below the operation area from the pseudo-change file; and acquiring edited results by applying the context differences from the operation history to the objective application file.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to high performance computing, and particularly to systems, methods and computer program products for operation history management for high performance computing programs optimization.

2. Description of Background

Currently, high performance computing (HPC) program optimization is usually done by directly editing a program using an editor. However, some editors have recently been developed that can support automatic functions for routine program changes for optimization. Loop unrolling conversion (conversions that expand execution strings in the loop according to N and change the number of loop repetitions to 1/N) is an example of a routine change for optimizing an HPC program. Conversions require much work time and can easily cause errors. However, if the editor can execute routine changes automatically, this would be helpful in supporting HPC program optimization. HPC program optimization requires a combination of direct program editing by an editor, which is the conventional method, and routine changes by commands that specify the conversation object and the parameters. From here, direct editing by an editor is referred to as ‘direct editing,’ routine program changes using commands that specify the conversion object and parameters will be referred to as ‘routine conversion,’ and a combination of these methods will be referred to as ‘program modification.’

Another characteristic of HPC program optimization is that it requires frequent reediting. In order to optimize an HPC program, a programmer needs to execute program editing based on the idea that the changes will improve performance, needs to compile and execute, and then needs to confirm efficiency by measuring performance. Program execution may require much time, so the effectiveness of multiple optimizations are usually confirmed at the same time. Also, optimizations that were executed previously may no longer be necessary due to other optimizations. The parameters (such as N mentioned in the above example) may also need to be modified.

Often, when an HPC program is optimized, past edits need to be undone or modified again. Therefore, it is necessary to flexibly manage the programmer's operation history in order to undo or modify past edits. Especially when past edited contents need to be modified again and the same object is repeatedly reedited in the future, it may not be possible to identify the location of the changed object for future edits. Past edits may add lines, so if the changed locations are managed simply by the line number, future edits may be applied to the wrong location.

In order to handle such situations, the conventional method is to use a version management system such as RCS and CVS to automatically readjust the operation history application location. These systems use the same or similar algorithm of the patch command in UNIX operating system for applying operation history to solve this problem. These conventional methods use file data from before and after editing including portions where the contents are different due to editing and the three lines above and below the edited line, which are referred to as context differences, in order to automatically readjust the operation history application location. This algorithm functions well when direct editing history is reapplied. Actually, routine conversion is not so common for rewriting normal programs. Also, most changes are applied to different portions of a program, so problems do not usually occur.

However, HPC program optimization often requires many routine conversions and changes to past operation history. Therefore, this method has problems because edited content differences are applied, and it is necessary to re-execute routine conversion commands when operation history is reapplied. For example, if the line that is the objective for unrolling is modified, and if the previous edited content differences are applied, a line is added before the changed portion and conversion cannot be executed correctly.

Tools to address version management problems during refactoring programs have been developed but are not sufficient for HPC optimization.

### SUMMARY OF THE INVENTION

Exemplary embodiments include a method for adjusting difference in an application area when operation history reapplication is executed by the system after operation history content changes are made, the method including in response to saving an operation history creating a pseudo-change file that includes marks above and below an operation area in order to specify an operation object, creating a change history by storing context differences between contents of a file before an operation and the pseudo-change file, including the context differences in an operation history list, in response to applying the operation history applying the context differences to an objective operation file to acquire the pseudo-change file, determining the application area based oil a position of the marks above and below the operation area from the pseudo-change file; and acquiring edited results by applying the context differences from the operation history to the objective application file.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides systems and methods for correctly readjusting objective application locations while taking into consideration past changes when the operation contents are reapplied based on past operation content changes, developing systems that manage operation history, developing systems that manage operation systems including both direct editing and routine conversion, and adjusting the differences in the application area when operation history reapplication is executed by the system after operation history content changes are made.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram of a system 100 for operation history management for high performance computing programs optimization;

FIG. 2 illustrates a flow chart of a method for operation history management for high performance computing programs optimization;

FIG. 3 illustrates a screenshot of an HPC program optimization tool in accordance with exemplary embodiments, and

FIG. 4 illustrates a screenshot of an Operation History View in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, the systems and methods described herein are implemented for correctly readjusting objective application locations while taking into consideration past changes when the operation contents are reapplied based on past operation content changes. The systems and methods described herein further develop systems that manage operation history.

In exemplary embodiments, the systems and methods described herein further develop systems that manage operation systems including both direct editing and routine conversion. Here, directly editing a program using an editor is referred to as ‘direct editing,’ and routine program conversion by specifying the conversion object and parameters and by using commands is referred to as ‘routine conversion.’ Booth operations are referred to collectively as ‘program changes.’

In exemplary embodiments, the systems and methods described herein manage program modification history in a list that contains order relationship information. It is possible to display recreated source file contents for programs after the operation specified by the user from the operation history.

In exemplary embodiments, it is also possible for the user to modify, add, and delete operation contents from the operation history list. If the user does not execute the changes after changing the operation history, the changes are not reflected to the operation history list. When the user acquires the contents of the program source file after making changes, the system automatically reapplies necessary operations after the changes.

In exemplary embodiments, if there is a difference with the application area due to changes to the operation history, the systems and methods described herein automatically make adjustments for reapplication by using the methods described herein. If the modification operation contains changed areas that overlap and the application area cannot be automatically adjusted, that change operation is notified to the user. In this case, the user should re-specify the application or should modify the operation contents in order to adjust the operation contents so that reapplication will be possible.

In exemplary embodiments, each operation from the operation history list is classified into the following three categories according to the reapplication necessity due to changes to the operation history and according to whether or not the automatic application area adjustments are successful. The following three categories are displayed using icon colors that correspond to the operation: 1) Already Applied <Green>: Reapplication for the objective operation is not necessary after changes to the operation history, or reapplication has already been executed; 2) Not Applied <Yellow>: Reapplication for the objective operation is necessary in the future after changes to the operation history, but reapplication has not yet been executed; and 3) Application Failure <Red>: Automatic reapplication for the objective operation was executed after operation history changes were made and failed. It is necessary for the user to make adjustments to the operation contents.

In exemplary embodiments, the systems and methods described herein can adjust the differences in the application area when operation history reapplication is executed by the system after operation history content changes are made. In on exemplary implementation, when saving routine conversion history, the systems and methods described herein create a file called a “pseudo change file” that has marks above and below the operation area in order to specify the operation object. Next, the systems and methods described herein store the context differences between the file contents before the operation and the pseudo-change file called a “pseudo differential file,” and then manage it as part of the operation history list.

In another exemplary implementation, when applying routine conversion history, the systems and methods described herein implement the same method as the conventional techniques such as CVS and RCS to apply the created “pseudo differential file” to the objective operation file, and acquire the “pseudo change file.” The systems and methods described herein use the acquired pseudo change file to determine the application area for the routine conversion command. Then, re-execute the routine conversion command to acquire the edited results after operation.

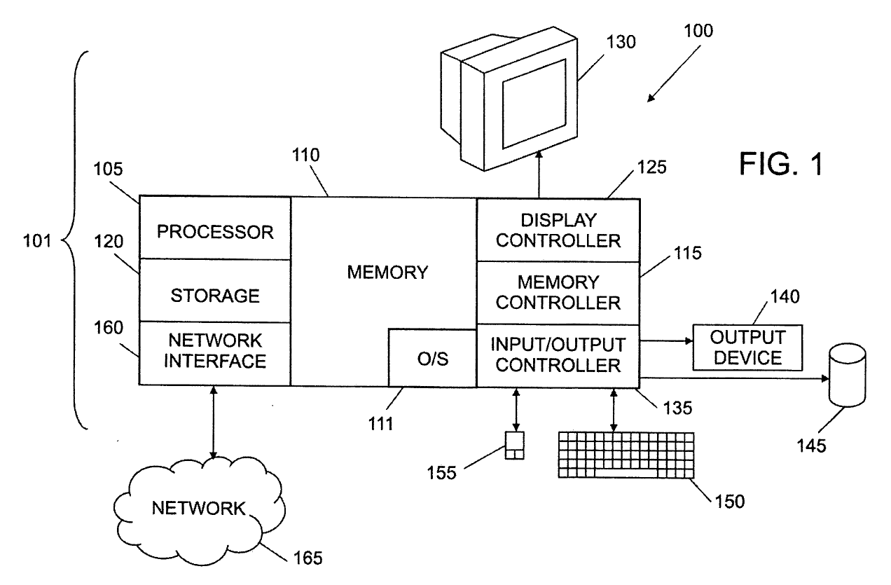

FIG. 1 illustrates a block diagram of a system 100 for operation history management for high performance computing programs optimization. The methods described herein can be implemented in software (e.g. firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the operation history management methods described herein in accordance with exemplary embodiments and a suitable operating system (OS) 111. The operating system 111 essentially controls the execution of other computer programs, such the operation history management systems and methods described herein, and provides scheduling, input-output control, file and data management, memory management, and communication control and related services.

The operation history management methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the operation history management methods can be written as au object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The operation history management methods described herein and the OS 111, in whole or in part, but typically the latter, are read by the processor 105, perhaps buffered within the processor 105, and then executed.

When the systems and methods described herein are implemented in software, as is shown in FIG. 1, the system and methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The operation history management methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), am erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the operation history management methods are implemented in hardware, the operation history management methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments: one or more processes in the memory 110 can monitor activity from the keyboard 150 and the mouse 155 or a combination thereof. The processes can further monitor long-running jobs that have been initiated on the computer 101. The processes can further monitor which and how many other machines can control the computer 101 either locally or remotely. In exemplary embodiments, the processes can also inquire or accept a grace period input by a user of the computer 101. The grace period can be a time period after which all traffic to and from the computer ceases if no further activity has been sensed by the processes. In this way, if a user has left the computer 101 for an extended period of time or has left the computer (e.g., after a work day) the computer 101 no longer allows traffic to and from the computer 101. In an alternative implementation, the computer 101 can totally power down after the grace period has expired. In further exemplary embodiments, the processes can accept traffic only from a common network maintenance control system that provides limited services.

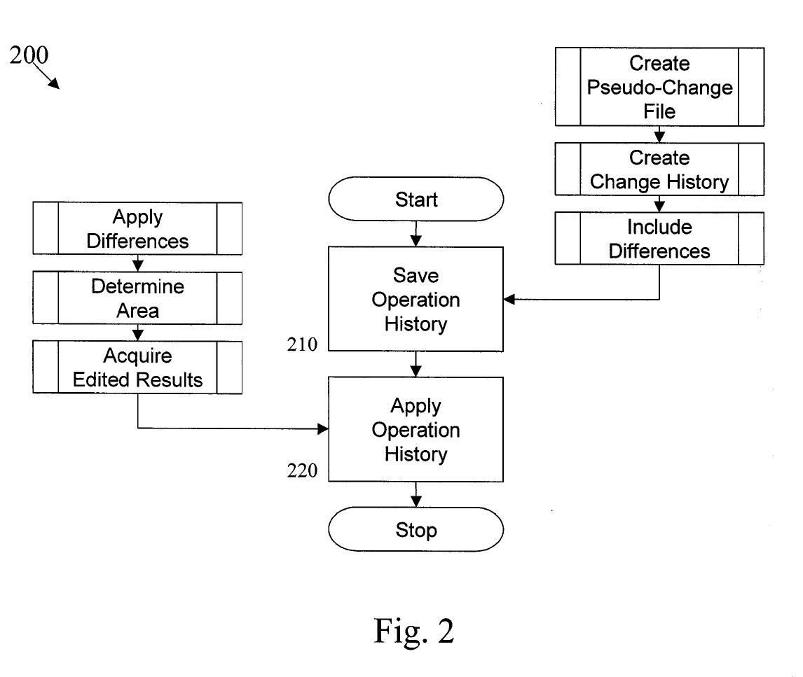

FIG. 2 illustrates a flow chart of a method 200 for operation history management for high performance computing programs optimization. At block 210, the method 200 can save an operation history and at block 220, the method 200 can apply an operation history. In exemplary embodiments, when the method 200 saves the operation history at block 210, the method 200 can further create a pseudo change file that contains special characters such as $BEGIN$ and $END$ at the beginning and end of the objective application area for the command specified by the routine conversion. In addition, the method 200 can create change history using the following data: 1) context differences between the file before editing and the pseudo change file (Line number area of the portion where there is a difference before and after editing such as the 15^{st} to 21^{st} lines and file contents including the three lines above and below the edited portion); 2) used commands (Such as loop unroll); and 3) arguments (Expansion number N from the above loop unroll example). In exemplary embodiments the method can also insert the created operation history to the correct position in the operation history list.

In exemplary embodiments, when the method 200 applies the operation history at block 220, the method 200 can also apply the context differences from the saved operation history into the objective application file, and then create a pseudo change file. In exemplary embodiments, the method 200 can: (1) Compare the line area of the context difference portion for the applicable file and the file contents including the three lines above and below the edited portion. If the areas match, replace the matching area with edited file contents and acquire the pseudo change file; (2) If the area in the above (1) does not match, ignore the specified line number area of the context difference, and search for whether there is a portion that matches with the file contents prior to editing including the three lines above and below the context difference in the objective application file. If there is a matching portion, that area will be considered as the application object. Replace that area with the file contents after editing so that the pseudo change file can be acquired; (3) If the area in the above (2) does not match, use only the two lines above and below the context difference data to execute the search and replace operation mention in the above (2); (4) If the area in the above (3) does not match, use only one line above and below the context difference data to execute the search and replace operation mention in the above (2); (5) If the area in the above (4) does not match, ignore all data above and below the context difference and execute the search and replace operation mention in the above (2); (6) If the area in the above (5) does not match, application of the application history will fail. This error will be informed to the user. In this situation, the user must directly specify the command application area.

In exemplary embodiments, the method 200 can further determine the command application area based on the position of the special characters such as $BEGIN$ and $END$ from die created pseudo change file. Furthermore, the method 200 can use the arguments from the operation history to apply the commands from the operation history to the determined application area. Finally, the method 200 can apply the context differences from the operation history to the objective application file, so that the editing results after the operation can be acquired. The method 200 re-executes commands by automatically adjusting the application change location for routine conversion the same as direct editing by the editor. As a result, it is possible to acquire the correct editing result after operation.

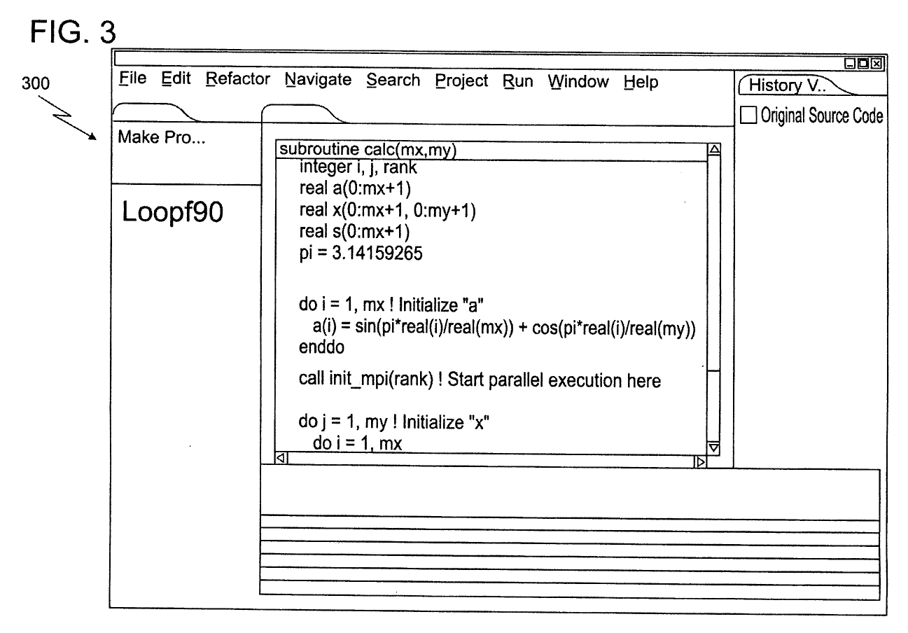

The following discussion describes an exemplary HPC program optimization tool that was developed based on the above method. FIG. 3 illustrates a screenshot 300 of an HPC program optimization tool. The left side of the screenshot 300 is the Source Code Tree View, which manages the source tree. The center of the screenshot 300 is the Source Code View, which is used to edit the current version of the program. The right side of the screenshot 300 is the Operation History View, which manages the operation history. And the bottom of the screenshot 300 is the Information and Console Output View, which outputs various data.

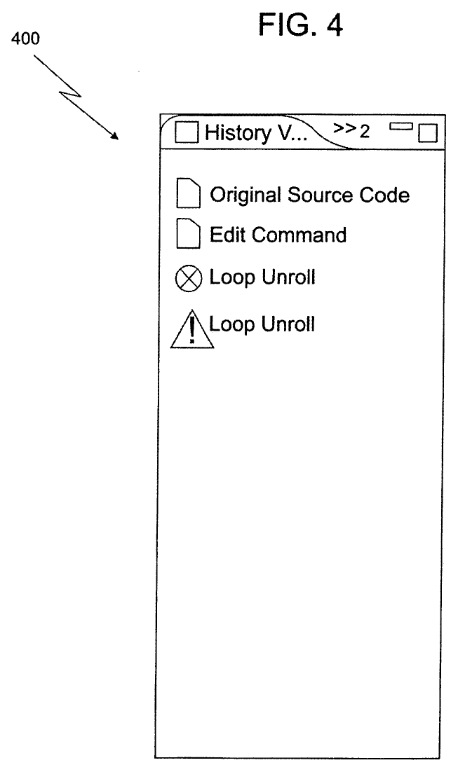

FIG. 4 illustrates a screenshot 400 of an Operation History View in accordance with exemplary embodiments. The screenshot 400 shows the operation history of the user according to the application order. History for both direct editing by the user editor and routine conversion by commands are displayed in the screenshot 400. The user can select the history icon from this View in order to select the editing results for the version after finishing corresponding operations as the current version. The current version that is selected is displayed in the Source Code View, and the user can edit the objective version. Based on these operations, the user can add or delete operation history by backtracking the arbitrary position of the operation history. For example, after selecting the latest operation history as the current version from the Operation History View, a new operation history is added to the end of the Operation History View if an edit is executed using the Source Code View. If the user executes an edit to the operation history that is not the latest as the current version in the Operation History View, an operation history is inserted next to the selected operation history. The version based on the history after the inserted operation history is not updated immediately. When the user specifies that history as the current version, the operation history is applied in order so that the version will be updated as needed. In exemplary embodiments, each operation history has three icons according to the corresponding update status: 1) Green icon: All necessary operation history has been applied for updating the corresponding version; 2) Yellow icon: Necessary operation history has not yet been applied for updating the corresponding version; and 3) Red icon: Necessary operation history has been applied in the past for updating the corresponding version. However, the operation application area has not been correctly identified. As a result, the operation history application failed (this is equivalent to what is mentioned in Applying Operation History 1 (6) of this document). In this situation, the user should select the corresponding operation history and manually specify the operation application area in order to reapply the operation. The user can delete or move operation history from this View.

It is therefore appreciated that the exemplary embodiments of the systems and methods described herein are implemented for automatically adjusting application locations and re-executing commands correctly for routine conversion history in addition to direct editing. As described above, tools have been developed in order to solve version management problems during refactoring programs. These conventional refactoring tools were developed to solve problems that the exemplary embodiments described herein can solve. In exemplary embodiments, the assumed usage conditions for these refactoring tools and for this invention are different. Therefore, different techniques are used when operation history is reapplied. Each technique has certain merits and demerits related to compatible usage conditions, conditions that automatically resolve conflicts, and required memory and processing time for implementation. One of major different points between these conventional refactoring tools and the exemplary embodiments described herein is assumed usage condition in editing without a specific (exclusive) tool. Because conventional refactoring tools are mostly used by the program owner in order to improve program maintainability, it is assumed that only a specific (exclusive) refactoring tool must be used to edit a specific program. On the other hand, it is assumed that the systems and methods described herein are used by software users to execute optimization according to their own computer architecture. Multiple programmers, including non software owner, may modify the version that is the source of the optimization without using a specific tool, or may modify the program in the future. Another major difference between refactoring tools and exemplary embodiments described herein is frequency of conflict occurrence and requests for automatic resolution. Objective program languages of conventional refactoring tools are mainly object-oriented languages. Change areas, such as inheritance relationship changes between variables/class names and objects, for refactoring are global. Therefore, the frequency of conflict occurrences between unrelated changes is relatively high. These conflicts can be resolved automatically by the refactoring tool. However, the object of this invention is HPC optimization, so conversion is mainly logical changes inside of the program. During optimization, bottlenecks at each hotspot in the program are resolved locally. Therefore, conflicts between two unrelated changes do not usually occur. And automatic solutions are not always best way for HPC optimization, because it is unknown whether performance is improved by applying multiple conversions at the same time. Therefore, if a conflict occurs, in most cases the best thing is for the user to decide.

When conventional refactoring tools are used, change locations are identified on the syntax tree of the source code just before the change, and conflicts are detected and resolved. However, when the systems and methods described here in are implemented, the objective area for change is identified in the source code just before the change. The merits of conventional refactoring tools are that change locations can always be determined correctly and unnecessary conflicts can therefore be minimized. However, there are also the following demerits with conventional refactoring tools.

In exemplary embodiments, in order to create a syntax tree for reference, the correct source code for just before the modification is needed. This becomes difficult if the source code before the modification can not be determined correctly such as when the program is updated by a patch without using the exclusive tool. Even if the source code can be correctly determined, implementation is complicated and processing increases when determining which portion of the syntax tree is changed and how it is converted by comparing source codes before and after the modification. For example, if a syntax tree is created for both source codes before and after modification, there should only be a few change locations of the syntax trees that require harmonizing. This requires a syntax tree creation process and a process for harmonizing the locations before and after the modification. As a result, implementation becomes complicated and execution time increases.

It is appreciated that the systems and methods described herein include more limited conditions for automatically resolving conflicts than conventional refactoring tools. When a conflict occurs, it is better for the user to make a decision instead of relying on automatic resolution. In addition, the systems and methods described herein have advantages over conventional refactoring tools when editing is executed using other tools. The systems and methods require less memory and processing time for implementation. Therefore, the systems and methods described herein are more suitable for performing HPC optimization.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. In a high performance computing system, a computer executed method for adjusting difference in an application area when operation history reapplication is executed by the system after operation history content changes are made, the computer executed method consisting of:
in response to saving an operation history:
creating a pseudo-change file that includes program changes represented by marks above and below an area in a file in which the program changes are made, the marks above and below the area specifying an operation object;
creating a change history representing the program changes by storing differences between contents of the file before an operation included in the program changes and the pseudo-change file,
wherein the operation is selected from the group consisting of already applied, not applied, and application failure;
including the differences in an operation history list;
in response to applying the operation history:
applying the differences to an objective operation file that acquires the pseudo-change file, by comparing three lines above and below a line in the file within the area in which the operation has been performed;
determining the area based on a position of the marks above and below the area from the pseudo-change file; and
acquiring edited results by applying the differences from the operation history to the objective application file.

2. (canceled)
